(19) United States
(12) Patent Application Publication
(10) Pub. No.: US 2017/0061555 A1
(43) Pub. Date: Mar. 2, 2017

(54) METHOD AND SYSTEM FOR PREDICTING LOWEST AIRLINE TICKET FARES

(71) Applicant: MasterCard International Incorporated, Purchase, NY (US)

(72) Inventors: Sourabh MAHESHWARI, Gurgaon (IN); Amit GUPTA, New Delhi (IN); Suneel BHATT, Delhi (IN)

(21) Appl. No.: 15/240,466

(22) Filed: Aug. 18, 2016

(30) Foreign Application Priority Data
Aug. 24, 2015 (SG) 10201506680Y

(51) Int. Cl. G06Q 50/14; G06Q 30/02; G06Q 30/06; G06Q 10/02

(52) U.S. Cl. CPC G06Q 50/14; G06Q 10/02; G06Q 30/0206; G06Q 30/0204; G06Q 30/0631

(57) ABSTRACT

Method and system for predicting a period with lowest airline ticket fares. The method comprises: receiving electronic payment transaction data relating to airline tickets; receiving flight data relating to a plurality of previous flights; generating, using a predictor module, historical reference data by associating the electronic payment transaction data with the flight data to determine, at least, a price of each of the plurality of previous flights; generating, using the predictor module, prediction data by fitting the historical reference data to a time-series model; receiving, from a user input module, user input data indicative of (i) departure location, (ii) arrival location and (iii) departure date of a future flight; predicting, using the predictor module, the period with lowest airline ticket fares based on the prediction data and the user input data; and transmitting the predicted period to a user output module to provide the user with an indication of a recommended period in the future to purchase a ticket for the future flight.

### CROSS-REFERENCE TO RELATED APPLICATION

This application is a U.S. National Stage filing under 35 U.S.C. §119, based on and claiming benefit of and priority to SG Patent Application No. 10201506680Y filed Aug. 24, 2015.

### FIELD OF INVENTION

The present invention relates broadly, but not exclusively, to methods and systems for predicting a period with lowest airline ticket fares.

### BACKGROUND

Currently, to book an airline flight, a traveller may directly visit the webpage of each airline that serves his desired route (i.e. departs from his location and arrives at his desired destination during his desired period). The traveller would need to manually compare the fares offered by each airline to determine which airline offers the lowest fare for his desired route. Alternatively, the traveller may visit flight-booking web portals run by online travel companies that provide flight-booking services. However, such web portals often claim to provide the cheapest flight tickets and their fares change frequently such that it is hard for the traveller to know when to buy the flight tickets and whom to buy the tickets from. The traveller may also use online search engines for airline flights (e.g. Skyscanner™). Such search engines do not sell flights directly (unlike the flight-booking web portals). Instead, such search engines are used to find the cheapest fares for a desired route after which users are automatically transferred to the airline or travel company's website to make their booking directly.

In all of the above cases, the traveller only has an indication of the lowest airline ticket fare at the time of checking the airline ticket fares for his desired route (i.e. either via an airline's website, flight-booking web portal or online search engine for airline flights). The traveller does not know if the fares he has found will be lower in the future or whether the fares are already at its lowest. In other words, the traveller does not have an idea of the airline ticket fares for his desired route in the future.

A need therefore exists to provide methods and systems for predicting lowest airline ticket fares that seek to address at least the above-mentioned problems.

### SUMMARY

According to a first aspect, there is provided a method for predicting a period with lowest airline ticket fares, the method comprising: receiving electronic payment transaction data relating to airline tickets; receiving flight data relating to a plurality of previous flights; generating, using a predictor module, historical reference data by associating the electronic payment transaction data with the flight data to determine, at least, a price of each of the plurality of previous flights; generating, using the predictor module, prediction data by fitting the historical reference data to a time-series model; receiving, from a user input module, user input data indicative of (i) departure location, (ii) arrival location and (iii) departure date of a future flight; predicting, using the predictor module, the period with lowest airline ticket fares based on the prediction data and the user input data; and transmitting the predicted period to a user output module to provide the user with an indication of a recommended period in the future to purchase a ticket for the future flight. The time-series model may be an autoregressive integrated moving average (ARIMA) model

In an embodiment, the method may further comprise dividing the historical reference data into a plurality of segments, wherein a duration of each segment is based on a time difference between the departure date and a time of receiving the user input data, and wherein the prediction data is generated by fitting the divided historical reference data to the time-series model.

In an embodiment, the duration of each segment may be one week if the time difference between the departure date and the time of receiving the user input data is equal to or less than one month. The duration of each segment may be two weeks if the time difference between the departure date and the time of receiving the user input data is equal to or less than six months but more than one month. The duration of each segment may be one month if the time difference between the departure date and the time of receiving the user input data is more than six months.

In an embodiment, the predicted time period with lowest airline ticket fares may correspond to the duration of each segment.

In an embodiment, associating the electronic payment transaction data with the flight data may comprise aggregating electronic payment transaction data corresponding to an electronic payment transaction with flight data corresponding to a previous flight that was paid through the electronic payment transaction.

In an embodiment, the electronic payment transaction data may comprise at least one of: a merchant category code (MCC), transaction date and transaction amount of an electronic payment transaction.

In an embodiment, the step of receiving electronic payment transaction data relating to airline tickets may comprise receiving electronic payment transaction data having an airline-related MCC.

In an embodiment, the method may further comprise: receiving, from the user input module, additional user input data indicative of: (i) name of airline, (ii) desired class of travel, (iii) flight departure time and (iv) a number of stop-overs, wherein the period with lowest airline ticket fares is predicted based on the additional user input data, in addition to the prediction data and the user input data.

In an embodiment, the flight data may comprise one or more of: name of airline, a departure location, an arrival location, class of travel, price of ticket, departure date, and arrival date of a segment of one of the plurality of previous flights.

In an embodiment, the step of predicting the period with lowest airline ticket fares may comprise generating a prediction of a price of the future flight on at least one airline.

According to a second aspect, there is provided a system for predicting a period with lowest airline ticket fares, comprising a predictor module, the predictor module comprising: at least one processor; and at least one memory including computer program code; the at least one memory and the computer program code configured to, with at least one processor, cause the predictor module at least to: receive electronic payment transaction data relating to airline tickets; receive flight data relating to a plurality of previous flights; generate historical reference data by associating the electronic payment transaction data with the flight data to determine, at least, a price of each of the plurality of previous flights; generate prediction data by fitting the historical reference data to a time-series model; receive, from a user input module, user input data indicative of (i) departure location, (ii) arrival location and (iii) departure date of a future flight; predict the period with lowest airline ticket fares based on the prediction data and the user input data; and transmit the predicted period to a user output module to provide the user with an indication of a recommended period in the future to purchase a ticket for the future flight.

In an embodiment, the predictor module may be further caused to divide the historical reference data into a plurality of segments, wherein a duration of each segment is based on a time difference between the departure date and a time of receiving the user input data, and wherein the prediction data is generated by fitting the divided historical reference data to the time-series model.

In an embodiment, the system may further comprise a database communicatively coupled with the predictor module, the database having stored therein at least one of: the electronic payment transaction data relating to airline tickets, the flight data relating to a plurality of previous flights, the historical reference data and the prediction data.

In an embodiment, a non-transitory computer readable medium having stored thereon executable instructions for controlling a predictor module to perform steps comprising: receiving electronic payment transaction data relating to airline tickets; receiving flight data relating to a plurality of previous flights; generating historical reference data by associating the electronic payment transaction data with the flight data to determine, at least, a price of each of the plurality of previous flights; generating prediction data by fitting the historical reference data to a time-series model; receiving, from a user input module, user input data indicative of (i) departure location, (ii) arrival location and (iii) departure date of a future flight; predicting the period with lowest airline ticket fares based on the prediction data and the user input data; and transmitting the predicted period to a user output module to provide the user with an indication of a recommended period in the future to purchase a ticket for the future flight.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a flow chart illustrating a method for predicting a period with lowest airline ticket fares according to an example embodiment;

FIG. 2 is a graph illustrating a prediction output according to an example embodiment;

FIG. 3 shows a schematic of a system for predicting a period with lowest airline ticket fares according to an embodiment of the invention; and

FIG. 4 shows an exemplary computing device suitable for executing the method for predicting a period with lowest airline ticket fares.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Currently, many merchants (airlines/travel companies) accept electronic payment transactions as an alternative to cash for the payment of airline tickets. In such electronic payment transactions, a payment card may be used. As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment for performing a transaction. Payment cards are typically uniquely tied to a consumer or card holder account. When a payment card holder (consumer/traveller) wishes to purchase an airline ticket from a merchant (airline/travel company), the payment card holder presents his/her payment card details to the merchant (in a “card-not-present” transaction). The merchant typically submits a request to an acquirer (a financial institution that processes and settles the merchant's transactions with the help of an issuer). The acquirer then sends the request to the issuer (a financial institution, bank, credit union or company that issues or helps issue cards to payment card holders) to authorize the transaction. A financial institution/payment facilitator (e.g. MasterCard®) acts as an intermediary between the acquirer and the issuer. If the acquirer authorizes the transaction (e.g. there are sufficient funds/credit in the payment card holder's account), the merchant releases the airline ticket to the payment card holder.

During a typical electronic payment transaction, certain data associated with the transaction (i.e. electronic payment transaction data) may be generated and the transaction data may be captured/collected by the payment facilitator. For example, the transaction data may be uploaded to a data warehouse on a regular basis (e.g. daily, weekly, monthly). If necessary, various algorithms/rules can be applied to anonymize the transaction data so that no personally identifiable numbers are available to the users of the transaction data.

The following types of transaction data can be may be generated/captured:

### Transaction Level Information:

Transaction ID
Account ID (anonymized)
Merchant ID
Transaction Amount
Transaction Local Currency Amount
Date of Transaction
Time of Transaction
Type of Transaction
Date of Processing
Cardholder Present Code
Merchant Category Code (MCC)

### Account Information:

Account ID (anonymized)
Card Group Code
Card Product Code
Card Product Description
Card Issuer Country
Card Issuer ID
Card Issuer Name
Aggregate Card Issuer ID
Aggregate Card Issuer Name

### Merchant Information:

Merchant ID
Merchant Name
MCC/Industry Code
Industry Description
Merchant Country
Merchant Address
Merchant Postal Code
Aggregate Merchant ID
Aggregate Merchant Name
Merchant Acquirer Country
Merchant Acquirer ID

### Issuer Information:

Issuer ID
Issuer Name
Aggregate Issuer ID
Issuer Country

The electronic payment transaction data can be used in conjunction with other types of data to predict a period with lowest airline ticket fares.

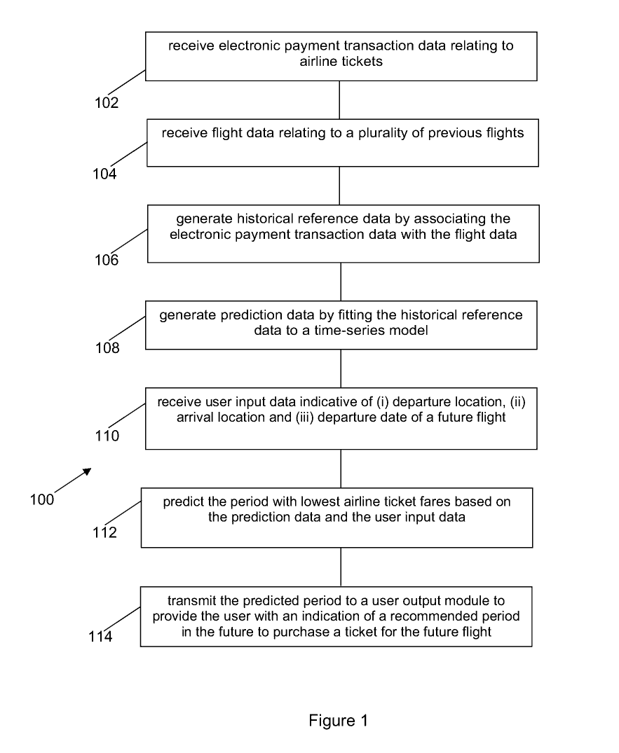

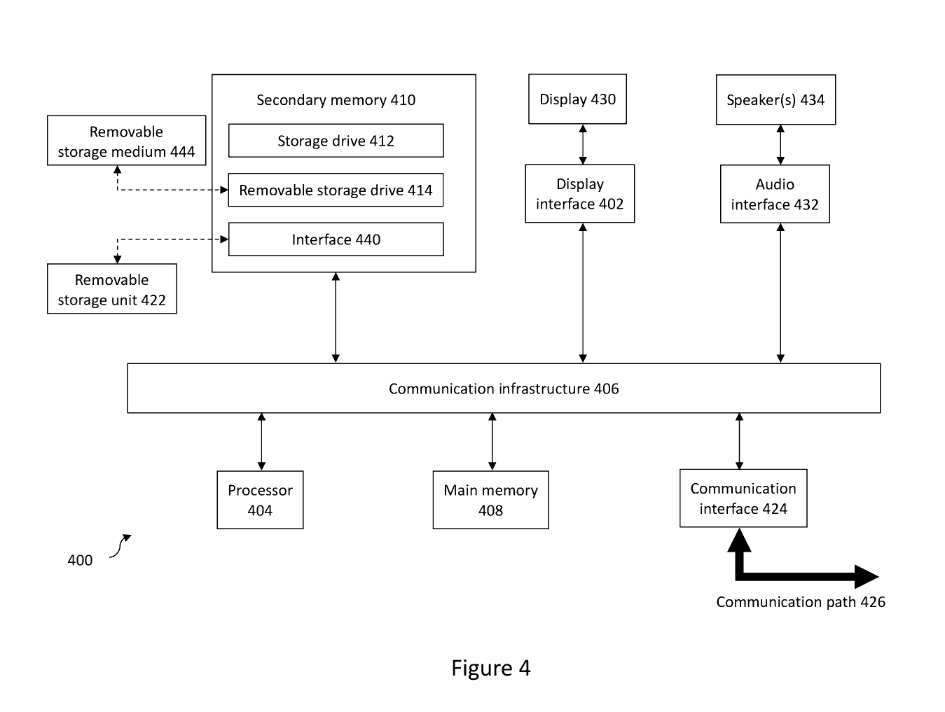

FIG. 1 shows a flow chart illustrating a method 100 for predicting a period (i.e. a time interval in the future) with lowest airline ticket fares, according to an embodiment of the invention. The method 100 may be performed by a purpose-built computing device such as a predictor module that is coupled to one or more databases. Further details on the predictor module and databases will be provided below with reference to FIGS. 3 and 4.

The method 100 comprises a step 102 of receiving/obtaining electronic payment transaction data relating to airline tickets. In particular, the electronic payment transaction data relates/corresponds to electronic payment transactions conducted in relation to the purchase of airline tickets. Details on the electronic payment transaction data have been provided above. The merchant category code (MCC) that is part of the transaction data can be used to identify transactions relating to airline tickets. In particular, by receiving electronic payment transaction data having an airline-related MCC, it may be possible to receive electronic payment transaction data relating to airline tickets.

Step 104 involves receiving/obtaining flight data relating to a plurality of previous flights. In the following description, “previous flights” refers to flights that have occurred prior to the time of executing the method for predicting a period with lowest airline ticket fares. These “previous flights” are used as a reference for the prediction. In the following description, a “segment” or “flight segment” refers to a discrete portion of a flight itinerary. All flights have at least one segment. On a nonstop flight, the sole segment is from the location where the plane took off to the final destination. On a flight with one stopover, there are two segments—the first from the departure location to the stopover/transit location, the second from the stopover/transit location to the final destination. Each segment has its own flight data. The flight data may comprise one or more of: name of airline, a departure location/airport, an arrival location/airport, class of travel (economy, business, first, etc.), price of ticket, departure date, and arrival date of the previous flight. Some locations may have more than one airport (e.g. New York has three airports—John F. Kennedy International Airport (JFK), LaGuardia Airport (LGA), and Newark International Airport (EWR)), therefore the traveller can specify his departure airport instead of his location.

For example, for a flight segment from Los Angeles to New York, the flight data may be “US$400 on economy class via XYZ Airlines; departs Los Angeles (LAX) on Tuesday 21 Jul. 2015 at noon and arrives at New York (JFK) at 6 pm”.

The flight data may be provided by airlines, third-party aggregators of flight data, or acquirers. The flight data may also be obtained from Internet websites/web portals or other publicly-available sources of information. The flight data may be stored on a database that is different or the same as the one containing the electronic payment transaction data.

The electronic payment transaction data relating to airline tickets (received at step 102) and flight data relating to a plurality of previous flights (received at step 104) are separate and distinct sets of data. That is, based on electronic payment transaction data alone, it is not possible to determine the flight data/information (e.g. name of airline, a departure location/airport, an arrival location/airport, class of travel, departure date, and arrival date). Likewise, using flight data alone, it is not possible to determine the electronic payment transaction details (e.g. when the flight ticket was purchased and ticket price).

Accordingly, step 106 involves using the predictor module to generate historical reference data by associating the electronic payment transaction data with the flight data to determine, at least, a price (transaction amount) of each of the plurality of previous flights. In an implementation, the step of associating the electronic payment transaction data with the flight data may comprise aggregating and/or linking electronic payment transaction data corresponding to an electronic payment transaction with flight data corresponding to a previous flight that was paid through the electronic payment transaction. In other words, if a particular previous flight (segment) was paid through an electronic payment transaction, details of that flight (segment) can be related to the details of the electronic payment transaction (e.g. merchant category code (MCC), transaction date and transaction amount). By aggregating/linking the electronic payment transaction data (received at step 102) and flight data (received at step 104), it is possible to determine the flight information corresponding to a particular electronic payment transaction; vice versa, it is possible to determine the details of the payment transaction corresponding to a particular previous flight.

The generated historical reference data may be stored in a database that is different or the same as the one containing the flight data and/or electronic payment transaction data. The generated historical reference data can be viewed as a data pool from which predictions are based on.

Step 108 involves using a predictor module (either the same predictor module used in step 106 or a different predictor module) to generate prediction data by fitting the historical reference data to a time-series model. The time-series model may, for example, be an autoregressive integrated moving average (ARIMA) model. ARIMA is a univariate model technique and takes only one variable/dimension. In an implementation, the input variable/dimension is an average price of an airline ticket. That is, the historical reference data comprises the average price of the airline ticket over a certain period of time. Based on this input variable/dimension, the ARIMA model provides a forecast of the future price of the airline ticket. That is, the prediction data comprises data relating to a forecast of the future price of the airline ticket.

Step 110 involves receiving/obtaining, from a user input module, user input data (i.e. a user's input) indicative of: (i) departure location, (ii) arrival location and (iii) departure date of a future flight. In the following description, “future flight” refers to a flight that the user wishes to obtain a prediction of a period with lowest ticket fares. The term “future flight” differs from “previous flight” in that the latter is used for predictions while the former is a flight for which a prediction is meant for.

Step 112 involves using the predictor module (either the same predictor module used in steps 106/108 or a different predictor module) to predict the period with lowest airline ticket fares based on the prediction data (generated at step 108) and the user input data (received at step 110). The duration of the predicted period may be a week (e.g. “Week number 40 of 2015” or “First week of September 2015”), first-half/second-half of a month (e.g. “First half of September 2015”) or whole month (e.g. “September 2015”) where ticket fares are expected to be the lowest from the time the prediction is generated to the flight departure date.

Besides the (i) departure location, (ii) arrival location and (iii) departure date of the future flight, the user can provide (via the user input module) additional user input data indicative of, but not limited to: (iv) name of airline, (v) desired class of travel, (vi) flight departure time, (vii) departure airport, (viii) arrival airport and (ix) a number of stop-overs. The period with lowest airline ticket fares is predicted based on the additional user input data, in addition to the prediction data and the user input data. In this manner, the results are more selective in the sense that only future flights that adhere to the user's additional criteria (i.e. additional input) are considered.

In an implementation, the length of the predicted period (i.e. weekly, bi-monthly, or monthly) varies depending on the additional step of dividing the historical reference data (which is generated at step 106) into a plurality of segments. A length or duration of each segment is based on a time difference between the future flight's departure date and a time of receiving the user input data (at step 110). In this implementation, the prediction data is generated by fitting the divided historical reference data to the time-series model. The duration of each segment is not fixed and can be changed depending on a user's requirements and preferences. For example, the duration of each segment may be one week if the time difference between the departure date and the time of receiving the user input data is equal to or less than one month. The duration of each segment may be two weeks if the time difference between the departure date and the time of receiving the user input data is equal to or less than six months but more than one month. The duration of each segment may be one month if the time difference between the departure date and the time of receiving the user input data is more than six months. In any case, the time period that is predicted (at step 112) to have the lowest airline ticket fares corresponds to the duration of each divided segment. For instance, if the time difference between the future flight's departure date and the time of receiving the user's input (i.e. user input data) is three weeks, the duration of each divided segment may be one week and accordingly the predicted time period has a duration of one week (e.g. “First week of September 2015”). In another example, if the time difference between the future flight's departure date and the time of receiving the user's input (i.e. user input data) is seven months, the duration of each divided segment may be one month and accordingly the predicted time period has a duration of one month (e.g. “September 2015”). The user can also choose to have the predicted time period in terms of weeks (i.e. Week 33 to 36 of 2015).

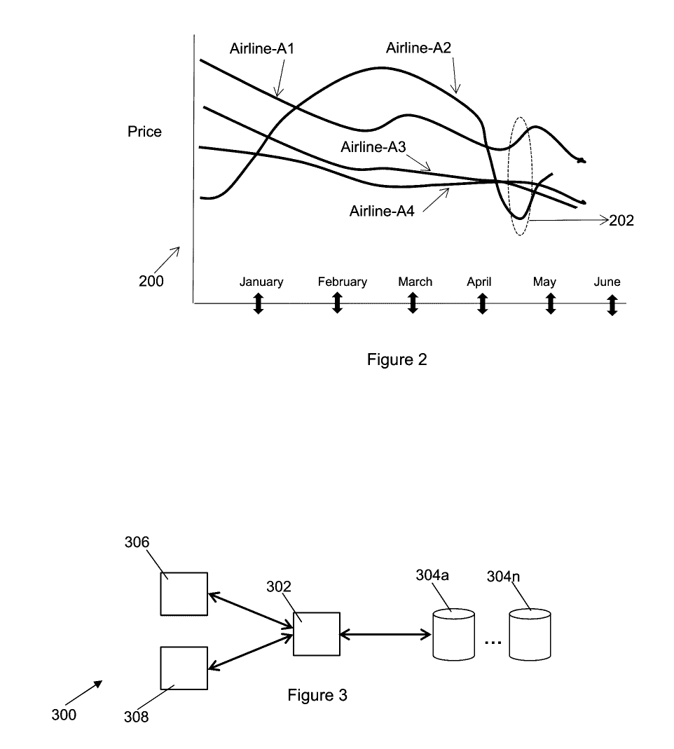

Step 112, which involves predicting the period with lowest airline ticket fares based on the prediction data and user input data, may comprise a sub-step of generating a prediction of a price of the future flight from at least one airline. FIG. 2 is a graph 200 illustrating an exemplary prediction output. The graph 200 shows airline ticket fare prices (x-axis) for a particular future flight over a period of time in the future (y-axis) for four airlines (Airline-A1, A2, A3 and A4). It can be seen that during a period demarcated by the reference numeral 202, the ticket fares for all four airlines are more or less at their lowest for the period of time. In particular, the fare offered by Airline-A2 is the lowest of all the airlines during the period between April and May.

Turning back to FIG. 1, step 114 involves transmitting the predicted period to a user output module to provide the user with an indication of a recommended period in the future to purchase a ticket for the future flight. Using the example of FIG. 2, the output module may indicate to the user that the recommended period in the future to purchase a ticket for the flight is “April to May on Airline-A2”. If the user provided an additional input that he only wishes to fly with Airline-A4, then the output module may indicate to the user that the recommended period in the future to purchase a ticket for the flight on Airline-A4 is “May to June”.

Embodiments of the invention advantageously facilitate booking of airline flights as the user only needs to input at least his desired (i) departure location, (ii) arrival location and (iii) departure date of a flight, and an indication of a recommended period in the future to purchase a ticket for the future flight is provided.

The steps of method 100 are in no particular order. For example, step 110 may be performed before step 102. Steps 102, 104, 106 and 108 may be performed regularly so that the prediction data is up-to-date.

FIG. 3 shows a schematic of a network-based system 300 for predicting a period with lowest airline ticket fares, according to an embodiment of the invention. The system 300 comprises a purpose-built computing device in the form of a predictor module 302, one or more databases 304a . . . 304n, a user input module 306 and a user output module 308. Each of the one or more databases 304a . . . 304n are communicatively coupled with the predictor module 302. The user input module 306 and a user output module 308 may be separate and distinct modules communicatively coupled with the predictor module 302. Alternatively, the user input module 306 and a user output module 308 may be integrated within a single mobile electronic device (e.g. a mobile phone, a tablet computer, etc.). The mobile electronic device may have appropriate communication modules for wired/wireless communication with the predictor module 302 via existing communication protocols.

The predictor module 302 may comprise: at least one processor; and at least one memory including computer program code; the at least one memory and the computer program code configured to, with at least one processor, cause the predictor module 302 at least to: (A) receive electronic payment transaction data relating to airline tickets; (B) receive flight data relating to a plurality of previous flights; (C) generate historical reference data by associating the electronic payment transaction data with the flight data to determine, at least, a price of each of the plurality of previous flights; (D) generate prediction data by fitting the historical reference data to a time-series model; (E) receive, from the user input module 306, user input data indicative of (i) departure location, (ii) arrival location and (iii) departure date of a future flight; (F) predict the period with lowest airline ticket fares based on the prediction data and the user input data; and (G) transmit the predicted period to the user output module 308 to provide the user with an indication of a recommended period in the future to purchase a ticket for the future flight.

In an implementation, the predictor module 302 may be further caused to divide the historical reference data into a plurality of segments. A duration of each segment is based on a time difference between the departure date and a time of receiving the user input data. In this implementation, the prediction data is generated by fitting the divided historical reference data to the time-series model. The predictor module 302 may be further caused to perform any of the method steps (102, 104, etc.) described above.

The various types of data, e.g. the electronic payment transaction data relating to airline tickets, the flight data relating to a plurality of previous flights, the historical reference data and the prediction data, can be stored in a single database (e.g. 304a), or stored in multiple databases (e.g. electronic payment transaction data is stored in database 304a, segment data is stored in database 304n, etc.). The databases 304a . . . 304n may be realized using cloud computing storage modules and/or dedicated servers communicatively coupled with the predictor module 302.

FIG. 4 depicts an exemplary computer/computing device 400, hereinafter interchangeably referred to as a computer system 400, where one or more such computing devices 400 may be used to facilitate execution of the above-described method for predicting a period with lowest airline ticket fares. In addition, one or more components of the computer system 400 may be used to realize the predictor module 302. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage medium 444 in a well-known manner. The removable storage medium 444 may include magnetic tape, optical disk, non-volatile memory storage medium, or the like, which is read by and written to by removable storage drive 414. As will be appreciated by persons skilled in the relevant art(s), the removable storage medium 444 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 440. Examples of a removable storage unit 422 and interface 440 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 440 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the inventions, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port (such as a serial, parallel, printer, GPIB, IEEE 1394, RJ45, USB), an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage medium 444, removable storage unit 422, a hard disk installed in storage drive 412, or a carrier wave carrying software over communication path 426 (wireless link or cable) to communication interface 424. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 440. Alternatively, the computer program product may be downloaded to the computer system 400 over the communications path 426. The software, when executed by the processor 404, causes the computing device 400 to perform functions of embodiments described herein.

In an embodiment, a non-transitory computer readable medium having stored thereon executable instructions for controlling a predictor module to perform steps comprising: receiving electronic payment transaction data relating to airline tickets; receiving flight data relating to a plurality of previous flights; generating historical reference data by associating the electronic payment transaction data with the flight data to determine, at least, a price of each of the plurality of previous flights; generating prediction data by fitting the historical reference data to a time-series model; receiving, from a user input module, user input data indicative of (i) departure location, (ii) arrival location and (iii) departure date of a future flight; predicting the period with lowest airline ticket fares based on the prediction data and the user input data; and transmitting the predicted period to a user output module to provide the user with an indication of a recommended period in the future to purchase a ticket for the future flight.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for predicting a period with lowest airline ticket fares, the method comprising:
receiving electronic payment transaction data relating to airline tickets;
receiving flight data relating to a plurality of previous flights;
generating, using a predictor module, historical reference data by associating the electronic payment transaction data with the flight data to determine, at least, a price of each of the plurality of previous flights;
generating, using the predictor module, prediction data by fitting the historical reference data to a time-series model;
receiving, from a user input module, user input data indicative of (i) departure location, (ii) arrival location and (iii) departure date of a future flight;
predicting, using the predictor module, the period with lowest airline ticket fares based on the prediction data and the user input data; and
transmitting the predicted period to a user output module to provide the user with an indication of a recommended period in the future to purchase a ticket for the future flight.

2. The method as claimed in claim 1, further comprising dividing the historical reference data into a plurality of segments, wherein a duration of each segment is based on a time difference between the departure date and a time of receiving the user input data, and wherein the prediction data is generated by fitting the divided historical reference data to the time-series model.

3. The method as claimed in claim 2, wherein the duration of each segment is one week if the time difference between the departure date and the time of receiving the user input data is equal to or less than one month.

4. The method as claimed in claim 2, wherein the duration of each segment is two weeks if the time difference between the departure date and the time of receiving the user input data is equal to or less than six months but more than one month.

5. The method as claimed in claim 2, wherein the duration of each segment is one month if the time difference between the departure date and the time of receiving the user input data is more than six months.

6. The method as claimed in claim 3, wherein the predicted time period with lowest airline ticket fares corresponds to the duration of each segment.

7. The method as claimed in claim 1, wherein the time-series model is an autoregressive integrated moving average (ARIMA) model.

8. The method as claimed in claim 1, wherein associating the electronic payment transaction data with the flight data comprises aggregating electronic payment transaction data corresponding to an electronic payment transaction with flight data corresponding to a previous flight that was paid through the electronic payment transaction.

9. The method as claimed in claim 1, wherein the electronic payment transaction data comprises at least one of: a merchant category code (MCC), transaction date and transaction amount of an electronic payment transaction.

10. The method as claimed in claim 9, wherein the step of receiving electronic payment transaction data relating to airline tickets comprises receiving electronic payment transaction data having an airline-related MCC.

11. The method as claimed in claim 1, further comprising:
receiving, from the user input module, additional user input data indicative of: (i) name of airline, (ii) desired class of travel, (iii) flight departure time and (iv) a number of stop-overs,
wherein the period with lowest airline ticket fares is predicted based on the additional user input data, in addition to the prediction data and the user input data.

12. The method as claimed in claim 1, wherein the flight data comprises one or more of: name of airline, a departure location, an arrival location, class of travel, price of ticket, departure date, and arrival date of a segment of one of the plurality of previous flights.

13. The method as claimed in claim 1, wherein the step of predicting the period with lowest airline ticket fares comprises generating a prediction of a price of the future flight on at least one airline.

14. A system for predicting a period with lowest airline ticket fares, comprising a predictor module, the predictor module comprising:
at least one processor; and
at least one memory including computer program code;
the at least one memory and the computer program code configured to, with at least one processor, cause the predictor module at least to:
receive electronic payment transaction data relating to airline tickets;
receive flight data relating to a plurality of previous flights;
generate historical reference data by associating the electronic payment transaction data with the flight data to determine, at least, a price of each of the plurality of previous flights;
generate prediction data by fitting the historical reference data to a time-series model;
receive, from a user input module, user input data indicative of (i) departure location, (ii) arrival location and (iii) departure date of a future flight;
predict the period with lowest airline ticket fares based on the prediction data and the user input data; and
transmit the predicted period to a user output module to provide the user with an indication of a recommended period in the future to purchase a ticket for the future flight.

15. The system as claimed in claim 14, wherein the predictor module is further caused to divide the historical reference data into a plurality of segments, wherein a duration of each segment is based on a time difference between the departure date and a time of receiving the user input data, and wherein the prediction data is generated by fitting the divided historical reference data to the time-series model.

16. The system as claimed in claim 14, further comprising a database communicatively coupled with the predictor module, the database having stored therein at least one of: the electronic payment transaction data relating to airline tickets, the flight data relating to a plurality of previous flights, the historical reference data and the prediction data.

17. A non-transitory computer readable medium having stored thereon executable instructions for controlling a predictor module to perform steps comprising:
receiving electronic payment transaction data relating to airline tickets;
receiving flight data relating to a plurality of previous flights;
generating historical reference data by associating the electronic payment transaction data with the flight data to determine, at least, a price of each of the plurality of previous flights;
generating prediction data by fitting the historical reference data to a time-series model;
receiving, from a user input module, user input data indicative of (i) departure location, (ii) arrival location and (iii) departure date of a future flight;
predicting the period with lowest airline ticket fares based on the prediction data and the user input data; and
transmitting the predicted period to a user output module to provide the user with an indication of a recommended period in the future to purchase a ticket for the future flight.
